(19) United States
(12) Patent Application Publication
(10) Pub. No.: US 2025/0094401 A1
(43) Pub. Date: Mar. 20, 2025

(54) SPACE EFFICIENCY IN LOG-STRUCTURED FILE SYSTEMS USING UNBALANCED SPLITS

(71) Applicant: VMware, Inc., Palo Alto, CA (US)

(72) Inventors: Quanxing LIU, Mountain View, CA (US); Wenguang WANG, Santa Clara, CA (US); Eric KNAUFT, San Francisco, CA (US); Enning XIANG, San Jose, CA (US); Salit GAZIT, Palo Alto, CA (US); Satish PUDI, Saratoga, CA (US)

(21) Appl. No.: 18/469,533

(22) Filed: Sep. 18, 2023

(51) Int. Cl. G06F 16/22; G06F 16/23

(52) U.S. Cl. CPC G06F 16/2246; G06F 16/2358

(57) ABSTRACT

A system manages a log-structured file system (LFS) by: receiving an input/output (I/O) operation for the LFS, the I/O operation prompting a key to be added to a first node of a tree metadata structure, the tree mapping addresses in a first address space to addresses in a second address space; determining that addition of the key to the first node would exceed a maximum number of keys allowed in the first node; adding a second node to the tree based on the determining, the second node containing the key; moving a quantity of keys from the first node to the second node such that a total number of keys resulting in the second node is less than half of the maximum number of keys, minus one, configured to be stored in nodes of the LFS; and writing updates to the tree metadata structure within the LFS.

### BACKGROUND

In the field of computer science, a log-structured file system (LFS) is a type of file system that writes data to nonvolatile storage (e.g., disk storage) sequentially in the form of append-only logs rather than performing in-place overwrites. This improves write performance by allowing small write requests to be batched into large sequential writes. The LFS may include one or more tree structures (e.g., “b-trees,” “b+-trees”) that are used to track a state of storage object(s) used by the LFS, such as mappings between a logical address space (addresses used by an underlying operating system and file system driver) and a physical address space (addresses used by an underlying storage subsystem, such as a vSAN or physical disk storage system). These tree structure(s) are metadata associated with the LFS that are updated when, for example, addresses are assigned (e.g., inserted into the trees) when allocating a new logical/physical block within the LFS, or when deallocating a logical/physical block within the LFS (e.g., removing from the trees).

A “b-tree” (often called a “self-balancing tree”) is a graph-based structure comprises nodes and edges, that implements particular rules during the building and modification of the trees that causes nodes to be balanced within the tree (e.g., to allow search efficiencies when traversing the tree). In the context of use with storage address space mapping, such self-balancing trees can be used to track, maintain, and search through the address mapping space to efficiently map an address from one address space (e.g., a logical address space containing logical block addresses) to another address space (e.g., a physical address space containing physical block addresses, or the like).

However, if conventional b-trees or b+-trees are applied to an LFS, inefficiencies can arise in certain situations due to the nature of LFS. Since log-structured file systems are typically implemented in write-heavy workload situations, LFS is typically append heavy (e.g., significantly more writing of new data blocks as compared to reads). If conventional b-tree or b+-tree rules are used for the LFS, this append-heavy workload can lead to additional computational processing, storage demands, and other inefficiencies during the management of these tree structures.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In some examples, a computerized method of managing a log-structured file system (LFS) on a computing device is provided. Solutions include: receiving an input/output (I/O) operation for the LFS, the I/O operation prompting a key to be added to a first node of a tree metadata structure, the tree metadata structure mapping addresses in a first address space to addresses in a second address space; determining that addition of the key to the first node would exceed a maximum number of keys allowed in the first node; adding a second node to the tree metadata structure based on the determining, the second node containing the key; moving a quantity of keys from the first node to the second node such that a total number of keys resulting in the second node is less than half of the maximum number of keys, minus one, configured to be stored in nodes of the LFS; and writing updates to the tree metadata structure within the LFS.

### BRIEF DESCRIPTION OF THE DRAWINGS

The present description will be better understood from the following detailed description read in the light of the accompanying drawings, wherein:

FIG. 1 illustrates an example architecture that advantageously implements a log-structured file system (LFS) using unbalanced splits;

FIG. 2 is an illustration of an example tree structure (or just “tree”) that may be used with an example architecture, such as that of FIG. 1;

FIG. 3A and FIG. 3B illustrate an example insert operation and the associated modifications that are performed on a tree while using unbalanced splits;

FIG. 4 is a flowchart of an example process that implements unbalanced splits during management of a middle tree, such as that shown in FIG. 1;

FIG. 5 is a flowchart of an example method managing an LFS on a computing device;

FIG. 6 illustrates an example virtualization architecture that may be used as a computing platform; and

FIG. 7 illustrates a block diagram of an example computing apparatus that may be used as a component of an example architecture, such as the architectures of FIG. 1 and FIG. 6.

Any of the figures may be combined into a single example or embodiment.

### DETAILED DESCRIPTION

In some log-structured file systems, workloads are append-heavy. In such situations, writes cause new mappings to be added to tree metadata structures that are used to track mappings between a logical address space and a physical address space, sometimes including one or more intermediary address spaces (“middle address spaces” or “virtual address spaces”). The use of b-trees or b+-trees may be used to manage such address mappings, helping to facilitate fast search and mapping between these layers of address spaces. However, conventional b*-trees are typically configured to provide a balanced configuration in each of the nodes of the tree. If these conventional b*-trees are used in LFS with append-heavy workloads (e.g., where new writes are frequent, and frequently require additions of higher and higher addresses in a middle address space), these workloads can cause increased overhead in management of the LFS, both in terms of computational processing in managing systemic changes to the tree after inserts, as well as storage overhead in writing all of the systemic changes to those trees.

In contrast, a filesystem driver manages an LFS and implements one or more trees for managing address mappings of the LFS. When a new key is to be added to a full node of the tree, the filesystem driver performs unbalanced splitting of the full node. This splitting causes a new node to be added to the tree, but the unbalanced nature of the split causes more keys or key/value pairs to be added to one node over the other. More specifically, more keys or key/value pairs are added to a left node, and less keys or key/value pairs are added to a right node. This accommodates an expected append-heavy workload, in which new inserts are more likely to be added to the right-most node of certain trees. Thus, by leaving available capacity in right-most nodes of a tree, the filesystem driver provides performance benefits to the management and overall performance of the LFS.

Examples of the disclosure improve the operations of the computer by improving the operation of log-structured file systems. When performing splits on the right-most nodes of a metadata tree that manages mappings between address spaces of the LFS, particularly a middle or virtual address space, both computational and storage efficiencies can be gained. More specifically, leaving available capacity for new keys or key/value pairs in right-most nodes of a b*-tree in append-heavy workloads allows new inserts to use less computational overhead as compared to a balanced split approach. Because new inserts are likely to occur in the right-most nodes of some b*-trees, a preemptive approach of unbalancing splits that favor more nodes to the left (e.g., leaving more capacity to the right) thus allows for more future inserts to occur in the right before other split operations are required. Further, since more extensive changes to the b*-tree implicate more storage updates to the tree, and thus more log-based writes of metadata to the LFS, a reduction in the amount of updates to the tree results in a reduction in storage requirements in the LFS.

While described with reference to virtual machines (VMs) in various examples, the disclosure is operable with any form of virtual computing instance (VCI) including, but not limited to, VMs, containers, or other types of isolated software entities that can run on a computer system. Alternatively, or additionally, the architecture is generally operable in non-virtualized implementations and/or environments without departing from the description herein.

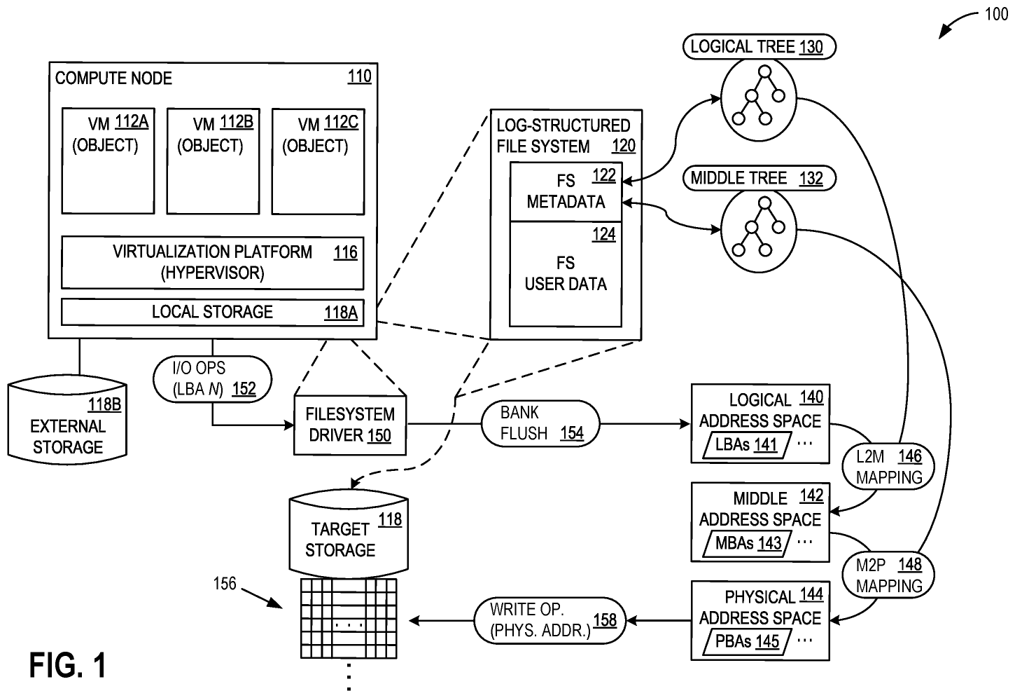

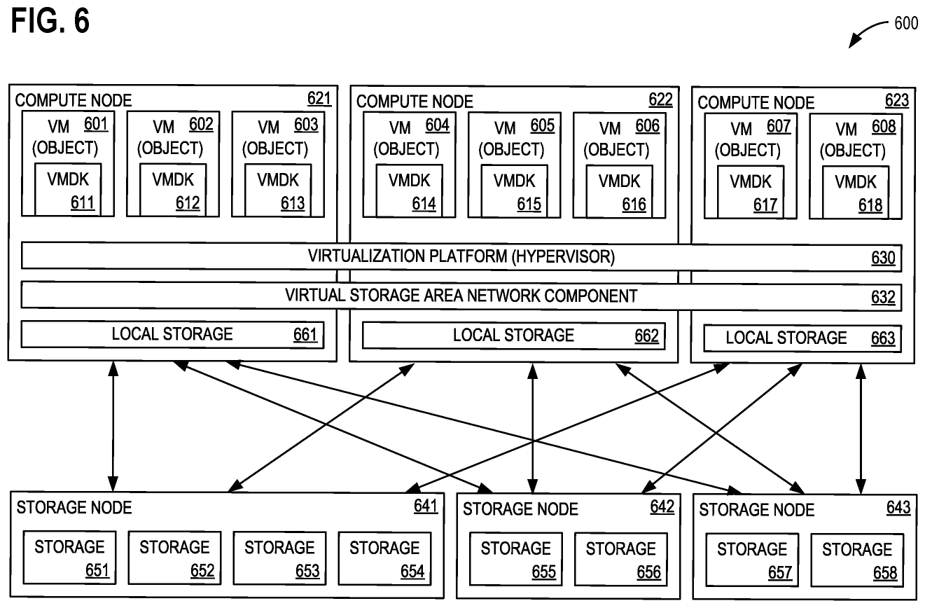

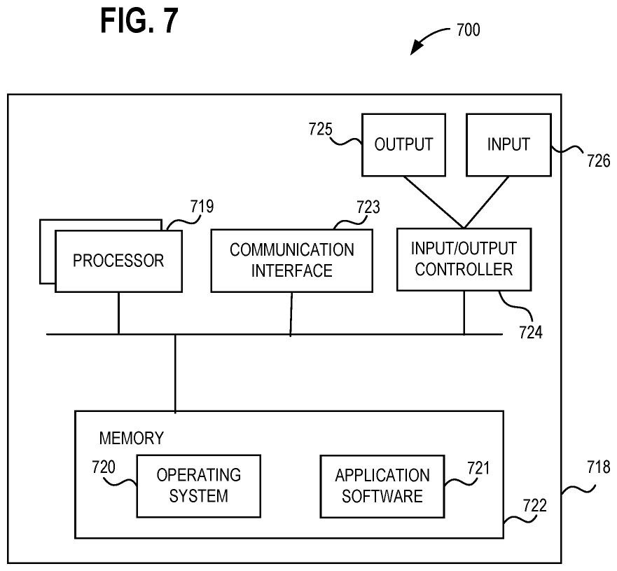

FIG. 1 illustrates an example architecture 100 that advantageously implements an LFS 120 using unbalanced splits. The architecture 100 uses a computing platform which may be implemented on one or more computing apparatus 718 of FIG. 7, and/or using a virtualization architecture 600 as is illustrated in FIG. 6. In this example, a compute node 110 includes an LFS 120 that is used to configure and manage some portion of disk storage of the compute node 110, such as a virtual disk, a logical volume, or the like. The LFS 120 is managed by a filesystem driver 150 that executes on the compute node 110 (e.g., as a driver of an operating system provided by one of the virtual machines (VMs) 112A-112C, within the virtualization platform 116, or the like). In this example, the filesystem driver 150 manages two tree metadata structures for the LFS 120, namely a logical tree 130 and a middle tree 132. To provide certain technical benefits, the filesystem driver 150 performs unbalanced splits during node splitting operations within one or more of these trees 130, 132. These unbalanced splitting systems and methods are described in greater detail herein.

In the example of FIG. 1, the LFS 120 is used to format and manage input/output (I/O) operations to/from persistent (e.g., non-volatile) storage space provided by one or more physical, persistent memory storage devices, referred to herein as “disk devices” or “storage devices” for brevity. The storage devices can include, for example, local storage 118A (e.g., disk devices directly connected to the compute node 110) or external storage 118B (e.g., storage provided by disk devices of a storage area network (SAN), network attached storage (NAS), cloud storage, or the like), and can include any type of persistent storage devices such as, for example, magnetic disks, solid state disks (SSDs), non-volatile memory (NVM) modules, and the like). This underlying storage of the LFS 120 is illustrated in FIG. 1 as target storage 118 (e.g., as a preconfigured number of blocks 156 of persistent storage provided by one or more of the disk devices of the storage subsystem).

Each of the blocks 156 of the target storage 118, in the example of FIG. 1, has a preconfigured size (e.g., in a number of bytes), such as 512 bytes, but can be of any size sufficient to support the systems and methods described herein. Further, each individual block 156 has a unique address within a physical address space 144. The physical address of a given block 156 is referred to herein as a “physical block address (PBA)” 145. In other words, each particular block 156 has a unique PBA 145 in the physical address space 144. These PBAs 145 thus may be used to reference particular blocks 156 of the target storage 118.

However, in the example of FIG. 1, the compute node 110 does not directly access the blocks 156 of the target storage 118 using the PBAs 145. Rather, the LFS 120 presents a logical address space 140 to the compute node 110, and the compute node 110 performs I/O operations to the LFS 120 using this logical address space 140. More specifically, this logical address space 140 is a user-facing address space that the user (e.g., the filesystem driver 150) uses to read and write blocks (or extents) of data from or to the target storage 118. The logical address space 140 is segmented into a set of logical blocks or extents (not separately shown) of a preconfigured size, with each logical block being assigned a unique logical address in this logical address space 140. The logical address of a given logical block or extent is referred to herein as a “logical block address (LBA)” 141. In this example, each logical block has a preconfigured size of 4096 bytes, but can be of any size sufficient to support the systems and methods described herein.

Further, in the example of FIG. 1, the LFS 120 also presents an intermediary address space, shown here as a middle address space 142. The middle address space 142 is an address space that is used internally to the LFS for mapping logical LBAs 141 of the logical address space 140 to PBAs 145 of the physical address space 144. The middle address space 142 uses “middle block addresses (MBAs)” 143 to reference middle blocks or extents (not separately shown). As such, the LFS 120 presents a three-tier address space for I/O operations performed on the LFS 120, where each LBA 141 is mapped to one or more MBAs 143 and each MBA 143 is mapped to one or more PBAs 145.

In some examples, either or both of the LBA to MBA (L2M) mapping 146 and MBA to PBA (M2P) mapping 148 utilize extent-based mappings. For example, a first mapping of LBA [10, 15) to MBA [100, 105) results in a key being inserted into the logical tree 130 (e.g., which provides the L2M mapping 146) and having a key value of 10 (e.g., the LBA 141 of address “10”) and a mapped value of {numBlks=5, MBA=100}(e.g., mapping to the MBA of “100”, and including five blocks starting from there, namely MBA blocks 100-104). If MBA [100, 105) maps to PSA 1000, 1004, 1006, 1007, 1009, respectively, then a key is inserted into the middle tree 132 (e.g., which provides the M2P mapping 148) and having a key value of 100 (e.g., the MBA 143 of address “100”) and a mapped value of {numBlks=5, PBA={1000, 1004, 1006, 1007, 1009}}(e.g., mapping the five MBA blocks 100-104 to PBA blocks 1000, 1004, 1006, 1007, 1009, respectively). In some examples, either or both of the L2M mapping 146 and M2P mapping 148, additionally or alternatively, utilize one-to-one mapping (e.g., where each key maps a single block in one address space 140, 142 to a single block in another address space 142, 144, respectively).

The illustrated example of LFS 120 includes two types of data that are written within the LFS 120, namely file system (FS) metadata 122 and FS user data 124. FS metadata 122 represents metadata (e.g., overhead storage) that is used to manage the LFS 120. FS user data 124 represents data that is written or read by the user (e.g., the compute node 110 and its associated operating system(s), applications, VMs 112, and the like). In other words, the FS user data 124 is the primary data stored by the LFS and the FS metadata 122 is overhead data that is stored in the LFS 120 and that is used to manage the LFS 120.

In this example, the LFS 120 maintains two tree structures as a part of the FS metadata 122, namely the logical tree 130 and the middle tree 132. More specifically, the logical tree 130 is used to perform address mappings from the logical address space 140 to the middle address space 142 (referred to herein as “L2M mappings” 146), and the middle tree 132 is used to perform address mappings from the middle address space 142 to the physical address space 144 (referred to herein as “M2P mappings” 148).

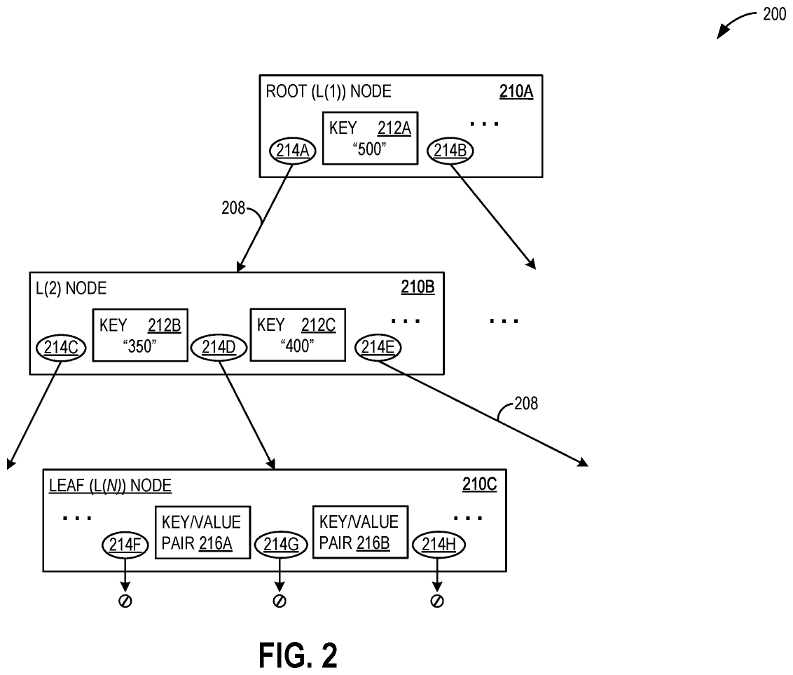

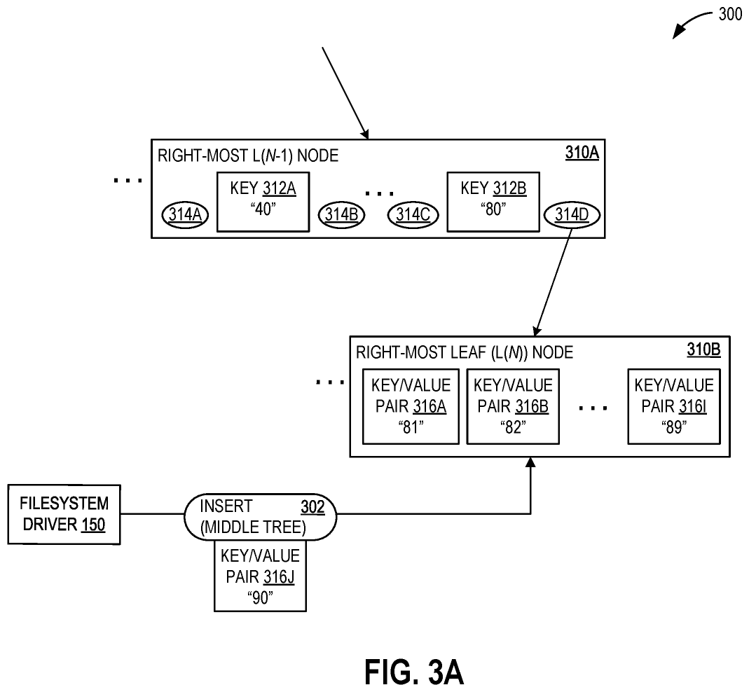

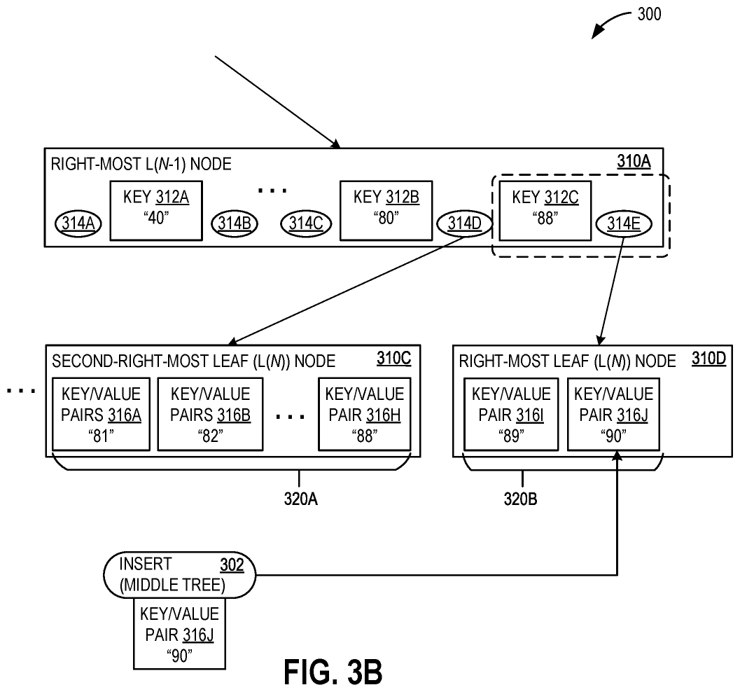

In some examples, either or both of the trees 130, 132 are b-trees (e.g., “balanced trees”). In some examples, either or both of trees 130, 132 are b+-trees. These two types of balanced trees may be referred to collectively herein as “b*-trees.” In either case, these trees 130, 132 utilize certain novel techniques or rules as compared to conventional balanced trees, as are explained in further detail herein. For example, balanced trees are discussed in FIG. 2, and methods for dynamic splitting of trees 130, 132 are discussed in FIG. 3A and FIG. 3B.

During operation, the filesystem driver 150 receives I/O operations (ops) 152 for the LFS 120. Many of these I/O ops 152 are write operations (e.g., write requests) to particular LBAs 141 of the LFS 120 (shown here as LBA N to illustrate one example I/O op 152). As write requests come into the filesystem driver 150, the writes are accumulated in an in-memory (e.g., transient memory) data structure called a “bank.” When the bank becomes full, a bank flush operation 154 is performed. During the bank flush operation 154, the user-provided data is appended to the FS user data 124 and the metadata in the FS metadata 122 is updated. Each of these writes is performed as a log-based write, as is typical with log-structured file systems. For example, one or more L2M mappings 146 are created during a bank flush operation 154 (e.g., inserting one or more key/value pairs into the logical tree 130) and one or more M2P mappings 148 may also be created (e.g., inserting one or more key/value pairs into the middle tree 132).

More specifically, in the example bank flush operation 154, for each write request in the bank, the filesystem driver 150 looks up the LBA 141 (or LBA range) within the logical tree 130. There are several possible scenarios for each write operation. In a first scenario, the LBA or the whole LBA range of a particular write request is covered by a single existing L2M mapping 146 in the logical tree 130. In this case, the filesystem driver 150 reuses the existing L2M mapping 146 (e.g., making no modification to the existing L2M mapping or to the M2P mappings 148), and thus this write will map through to the same blocks 156 of the target storage 118. In a second scenario, no existing L2M mapping 146 is found in the logical tree 130 that includes either the single LBA 141 or any LBAs 141 of an extent identified by the write request. In this case, the filesystem driver 150 allocates new MBA(s) 143 and PBAs 145 for this write request, then updates the L2M mappings 146 and M2P mappings 148 in both the logical tree 130 and in the middle tree 132. In the example, MBAs 143 are allocated in monotonically increasing (or decreasing) order. In a third scenario, some of the LBAs 141 of the write request already appear in the L2M mappings 146 (e.g., in the logical tree 130), but some do not. In this case, the filesystem driver 150 identifies these overlapping L2M mappings 146 and removes all the M2P mappings 148 found in the middle tree 132 for those overlapping mappings, and then adds new mappings as in the second scenario.

As such, the bank flush operation will cause all these metadata changes to the trees 130, 132 to be written as FS metadata 122 to the LFS 120. Further, the filesystem driver 150 also writes the user-provided data of the write requests as FS user data 124 to the LFS 120, as each block of data from the write request can now be mapped through to a block 156 (e.g., a PBA 145) of the target storage 118. Each of these writes results in a write operation 158 to one or more blocks 156 of the target storage 118 (e.g., based on the L2M mapping 146 and M2P mapping 148 of the logical address(es) identified by the associated I/O op 152).

During these bank flush operations, when a node of one of the trees 130, 132 is full, the filesystem driver 150 splits that node into two nodes (e.g., a left node and a right node), with each new node containing roughly half of the key/value pairs of the original node. However, the middle tree 132 has an append-heavy workload (e.g., increasing the next MBA 143 for the next new assignment of LBAs 141, regardless of the user I/O pattern). As a result, efficiencies of the middle tree 132 are improved through unbalanced splits. FIG. 3A and FIG. 3B illustrate example methods for performing unbalanced splits in this architecture 100.

FIG. 2 is an illustration of an example tree structure (or just “tree”) 200 that may be used with the architecture 100 of FIG. 1. In some examples, the tree 200 is used as either or both of the logical tree 130 or the middle tree 132 of FIG. 1. In some examples, the tree 200 is a b-tree, a “balanced search tree” directed graph structure in which each node 210A-210C (collectively, nodes 210) contains key/value pairs. In this example, the tree 200 is a b+-tree, which is a variant of the b-tree in which only leaf nodes 210C contain key/value pairs 216A and internal nodes (also referred to herein as “index nodes” or “non-leaf nodes”) contain the key but do not contain the associated “value” (e.g., the mapped value) portion of the key/value pair. Instead, these “separator” keys appear as keys 212A, 212B, 212C (collectively, keys 212) in interior nodes (e.g., in the root node 210A, in the example level 2 (“L2”) node 210B), and also have a key/value pair 216A in one of the leaf nodes 210C of the tree 200.

B*-trees are directed graph structures that can be used in search and indexing applications (e.g., as a variant of an m-way search tree, but with specific rules for modifying the tree structure). A b*-tree includes one or more nodes 210 connected by directional edges 208. Each node contains at least one key/value pair and may have pointers 214A-214H (collectively, pointers 214) to one or more children nodes (e.g., in the case of the node being a non-leaf node, or an internal node) or no pointers to any children nodes (e.g., where the node is a leaf node). The pointers are represented by the directed edges of the tree.

Each key of a node has a value (e.g., a “key value”). The key value represents a value in a search space that is used to locate some target data (e.g., some data associated with a particular value in a domain of the search space). The key value is used to evaluate against other key values on some linear domain while traversing the b*-tree (e.g., integers that can be compared to determine whether one is larger, the same as, or smaller than another, or the like). In FIG. 2, key values are shown as quoted integers in only unpaired keys 212A-212C for purposes of discussion, but it should be understood that the keys of key/value pairs 216A, 216B also have key values, but those key values are not shown in FIG. 2 for purposes of brevity.

Further, in a b-tree, each key is paired with a value. This paired value is referred to herein as “mapped value” to distinguish from the “key value,” which is a value of the key itself. The mapped value is the resultant data to be returned from the search. In other words, a search operation represents traversing the b-tree to find a particular key value, and when that key value is found, the mapped value is returned as the result of the search. As such, in the key/value pairs, the values of the keys represent the domain of the mapping (e.g., the search space of the inputs), and the mapped values represent the range of the mapping (e.g., the returned values from the completed search). In a b+-tree, these key/value pairs differ slightly from b-trees. As shown in FIG. 2, only leaf nodes of a b+-tree contain key/value pairs 216A, 216B. All non-leaf nodes, such as the root node 210A and the L2 node 210B, contain unpaired keys 212A-212C (e.g., keys without a paired value).

In addition to the key/value pairs 216A (and unpaired keys 212A-212C for b+-trees), each key 212A-212C of a non-leaf node 210A, 210B also has two pointers, namely a “left pointer” and a “right pointer” (represented in FIG. 2 as pointers 214A-214E, appearing to the left or right of any given key 212A-212C). In any given set of {left pointer, key, right pointer}, the left pointer points to a left child node and the right pointer points to a right child node. Further, the tree is structured such that the left child node contains only keys having key values that are less than the key value of the parent key, and that right child node contains only keys having key values that are greater than the key value of the parent key. In the case of b+-trees, the key value of the parent key also appears in a leaf node somewhere below this internal node and, as such, b+-trees change the test to “less than or equal to” or “greater than or equal to” in the testing for either the left child node or right child node, respectively (e.g., depending on whether the key value of this parent key is added down the left side or right side from this internal node).

By way of example, consider the key 212A shown in the root node 210A and its left pointer 214A and right pointer 214B. The left pointer 214A points to the L2 node 210B (the “left side child” of key 212A), as shown in FIG. 2, and the right pointer 214B points to another L2 node (not shown) (the “right side child” of key 212A). This example key 212A has a key value of “500”. As such, all the keys 212B, 212C in the L2 node 210B are less than (or “less than or equal to”, in some b+-tree cases) the key value of “500”. Similarly, all the keys in the right-side L2 node pointed to by pointer 214B are greater than (or “greater than or equal to”, in other b+-tree cases) the key value of “500”.

As such, during a search traversal of the b*-tree, if a search value is less than the key value of the parent key, then the search continues to the left child node (or to some child of another key to the left of that key in this parent node), and if the search value is greater than the parent key, then the search continues to the right child node (or to some child of another key to the right of that key in this parent node). In situations where there are multiple keys in a particular internal node, those keys are ordered by their key values, and each two adjacent keys may share a child pointer (e.g., a right child pointer of one key may be the left child pointer of the next higher key in the node). For example, in the L2 node 210B of FIG. 2, key 212B shares its right-side child pointer 214D with key 212C, which is the left-side child pointer 214D of that key 212C. As such, if a given internal node has n keys, then the node will also include n+1 pointers to child nodes.

Leaf nodes 210C have key/value pairs 216A, 216B. Leaf nodes 210C may also have pointers 214F-214H, but because these are leaf nodes of the tree 200, these leaf nodes 210C have no children, and thus the pointers 214F-214H do not point to any other nodes 210 (represented in FIG. 2 as null pointers).

Any particular b*-tree may be configured with an order, m, where m identifies a maximum number of children that any internal node may have (e.g., each non-leaf node can have at most m children), as well as a maximum number of keys 212 or key/value pairs 216 within each node (e.g., m−1 key/value pairs in any node). For example, in an m=4 b*-tree, any non-leaf node 210A, 210B can have at most four children, and any node 210 can have at most three key/value pairs 216 (or keys 212 in non-leaf nodes of b+-trees). Such b*-trees have rules associated with aspects of their construction and modification.

In conventional b-trees and b+-trees, these rules include, for example:
a. internal nodes include at least ceiling(m/2) children and at most m children;
b. each internal node except the root node has at least ceiling(m/2) keys and at most m−1 keys;
c. the root node can have a minimum of 2 children unless it is itself a leaf node, in which case it can have zero children;
d. the keys in each node are sorted in order of their key value (e.g., in either increasing or decreasing order); the keys in each node act as separators or dividers that divide the keys of its child nodes (e.g., where all keys in the left child node are less than the separator/parent key, and all keys in the right child node are greater than the separator/parent key, or vice versa);
e. all leaf nodes are at the same level and do not have any children; and
f. each child of an internal node is itself a b*-tree; and addition of new nodes is performed bottom-up.

In this example, these rules are modified to incorporate aspects of unpaired splits in certain situations, as is discussed in greater detail herein. In some examples, the tree 200 is a b+-tree used for the logical tree 130 and/or the middle tree 132 of FIG. 1. In such implementations, the domain of the tree 200 represents one of the address spaces of the LFS 120, with the range of the tree 200 representing another of the address spaces of the LFS 120. More specifically, in the case of the logical tree 130, the domain of the tree 200 represents the logical address space 140 and the range of the tree 200 represents the middle address space 142, thus representing the L2M mapping 146 (e.g., where a search operation on an LBA 141 yields an MBA 143). In the case of the middle tree 132, the domain of the tree 200 represents the middle address space 142 and the range of the tree 200 represents the physical address space 144, thus representing the M2P mapping 148 (e.g., where a search operation on an MBA 143 yields a PBA 145).

FIG. 3A and FIG. 3B illustrate an example insert operation 302 and the associated modifications that are performed on a tree 300 while using unbalanced splits. In some examples, the tree 300 is similar to the logical tree 130 or middle tree 132 of FIG. 1, or to the tree 200 of FIG. 2, and is a b-tree or a b+-tree. In some examples, keys 312 may be similar to keys 212, pointers 314 may be similar to pointers 214, and nodes 310 may be similar to nodes 216 shown in FIG. 2. In this example, the tree 300 is a b+-tree that is implemented as the middle tree 132 and, as such, the domain of the tree 300 is the middle address space 142 and the range of the tree 300 is the physical address space 144 of FIG. 1.

In this example, the filesystem driver 150 is performing the insert operation 302 to insert a new key/value pair 316J into the tree 300. This example presumes that the key value of the new key/value pair 316J is not already in the tree 300. The insert operation 302 is, for example, in response to the bank flush operation 154 of FIG. 1. In FIG. 3A and FIG. 3B, only the key values of the keys 312 and key/value pairs 316 are shown (as quoted integers) for ease of discussion, but it should be understood that these key values represent MBAs 143 of the middle tree 132 in this example.

This example insert operation 302 causes the filesystem driver 150 to search the tree 300 for a place to insert a key value of “90” (of the key/value pair 316J) into the tree 300 (and presuming that the key value of “90” is not already in the tree). To locate a proper insert location for this new key/value pair 316J, the filesystem driver 150 traverses the tree 300 using the key value of “90”, starting at the top node (e.g., the root node 210A) and stepping to a next level of the node based on comparisons of the key value to key values of keys in the current node, as is common with b*-trees. In b-trees, the search may end at a non-leaf node if a match for the sought-after key value is found before the bottom layer is reached. In this example, this traversal ends at one of the leaf nodes 210C and, as such, causes an insert of the new key/value pair 316J at this level.

In the example, the key value of “90” is larger than any of the keys currently in the tree 300 and, as such, this traversal has led the filesystem driver 150 from the root node 210A (not shown in FIG. 3A) down through the right-most L(N−1) node 310B (which has keys ranging from “40” to “80”), and down to the right-most leaf L(N) node 310B via the pointer 214D (e.g., because “90” is greater than the “80” key value of key 312B). In this example, it is presumed that the order of the tree is 10 (e.g., m=10), making the maximum number of keys 312A-312C or key/value pairs 316A-316J in any particular node 310A-310C to be nine (e.g., m−1).

Currently, as shown in FIG. 3A, node 310B has been identified as the node for this insert operation 302. However, this node 310B already has nine key/value pairs 316A-316I (e.g., key values “81” through “89”), the maximum number of key/value pairs 316 for an order 10 tree. As such, because adding the new key/value pair 316J would exceed the maximum allowed number of key/value pairs per node, the filesystem driver 150 performs a split operation on the node 310B.

More specifically, and referring now to FIG. 3B, the filesystem driver 150 splits the node 310B into two nodes 310C and 310D, shown here as the “second-right-most leaf (L(N)) node” (node 310C, also referred to herein as the “left-side node” of this split operation) and the “right-most leaf (L(N)) node” (node 310D, also referred to herein as the “right-side node” of this split operation). The filesystem driver 150 determines the set of key/value pairs 316 to be distributed between these two nodes 310C, 310D. In this example, the set of key/value pairs 316 to be distributed between the two nodes 310C and 310D includes a total of ten key/value pairs, namely key/value pairs 316A-316J (e.g., ten keys with key values of “81” to “90”).

In a conventional b*-tree, the set of key/value pairs 316A-316J are split evenly amongst the two nodes 310C, 310D. For example, in an even split operation under a b+-tree, the keys of “81” to “85” may be placed into node 310C, and the keys “86” to “90” may be placed into node 310D (e.g., an even five/five split). In an even split operation under a b-tree (not shown), the keys “81” to “84” may be placed into node 310C, the key “85” may be moved up to the parent node 310B, and the other keys “86” to “90” may be placed into node 310D (e.g., in an even 4/5 or 5/4 split, as even as can be had with an even order). In other examples (e.g., when the order, m, is odd), such as when m=9, a balanced split is 5/4 or 4/5 under b+-trees.

Here, however, the filesystem driver 150 performs an unbalanced split in this example. More specifically, in examples, from the set of key/value pairs 316A-316J to be distributed, the filesystem driver 150 determines a first subset 320A of key/value pairs to use in the left-side node (e.g., node 310C) and a second subset 320B of key/value pairs to use in the right-side node (e.g., node 310D). In this example, the filesystem driver 150 uses a split percentage of 80/20 (e.g., 8 and 2), or 80% of the keys (e.g., key/value pairs 316A-316H) with the smaller key values to the left-side node 310C and 20% of the keys (e.g., key/value pairs 316I-316J) with the higher key values to the right-side node 310D. It should be noted that, while node 310C is illustrated here as a “new” node, this node 310C may be the node 310B from which this split occurred. In such implementations, only a few keys 312 or key/value pairs 316 may be removed from the node 310B (e.g., removal of key/value pair 316H), resulting in the node 310C of FIG. 3B.

In some examples, the values stored in the key/value pairs 316A-316J are variable-sized values. Variable-sized values means that the sizes of the values can be different (e.g., where some values use 8 bytes and other values use 40 bytes). In some examples, a b+-tree is used as the middle tree 132 and the values of the middle tree 132 are variable in size (e.g., where the minimum and maximum size of middle tree values are known). For B*-trees with variable-sized values, the example unbalanced splitting will result in the left node having significantly more space used than the right node, and the number of keys in these nodes may differ significantly (e.g., where one node contains a large number of small values while the other contains just a few big values). In this example, n is a maximum number of smallest key/value pairs in a leaf node of the b+-tree (e.g., similar to m, which applies to index nodes). b is used as a configuration variable for leaf nodes (e.g., in lieu of ceiling(n/2)). b is a minimum number of key/value pairs in a leaf node of the b+-tree. As such, b=ceiling((maximum number of largest key/value pairs in a leaf node)/2). When performing unbalanced splits, after inserting the new key into the new right-most leaf, the leaf will not underflow (e.g., have fewer than b keys). As such, for unbalanced splits, the resulting new rightmost leaf should have at least b−1 key/value pairs. Then after inserting the new key/value pair, the new rightmost leaf will have at least b keys and will not underflow. Additionally, in the middle tree, the condition for triggering an unbalanced split is not necessarily “the original leaf has n key/value pairs.” Rather, whenever a leaf node does not have enough space to insert a new key/value pair, an unbalanced split is triggered. The splitting node may not have as many as n key/value pairs due to the variable-sized values. And similarly, for the case of b-trees, if the value is variable-sized, there will be a b parameter for all nodes.

In other examples, other unbalanced splitting configurations are performed that control the unbalanced nature of these unbalanced split operations. For example, the filesystem driver 150 includes a preconfigured split setting, b, that is used to determine how to split keys 312 or key/value pairs 316 between two nodes when performing an unbalanced split. For example, the unbalanced setting, b, is an integer value or percentage value that can be used to identify how many keys 312 or key/value pairs 316 go to the left-side node 310C during a split operation (or the inverse, how many go to the right-side node 310D). If, for example, b=60% to the left, then the number of keys 312 or key/value pairs 316 added to the left-side node 310C is num_left=ceiling((m+1)*b) with the remainder of num_right=(m+1)−num_left going to the right-side node 310D. In some examples, b is a number of keys or key/value pairs (e.g., as some value less than m+1 and greater than m/2). For example, if b=7, then num_left=7 keys 312 or key/value pairs 316 are added to the left-side node 310C and num_right=(m+1-b) keys 312 or key/value pairs 316 are added to the right-side node 310D. In some examples, b is a minimum number of keys 312 or key/value pairs 316 that can be in any non-root node 310 (e.g., even unbalanced nodes), and b may be used to determine how many keys to add to the right node 310D. For example, if b=2, then num_right=b, and num_left=(m+1−b). In some examples, split values can include 60%/40%, 70%/30%, 90%/10%, 100%/0%, or any percentage or absolute number that causes an imbalance of at least two additional keys 312 or key/value pairs 316 to be added to the left-side node 310C as compared to the right-side node 310D during a split.

As such, in this example, the filesystem driver 150 updates the tree 300 with the two nodes 310C, 310D, adding key/value pairs 316A-316H into node 310C and key/value pairs 316I-316J into node 310D, thus creating an unbalanced split between these two nodes 310C, 310D. This unbalanced split leaves room for one new key/value pair 316 in the left-side node 310C, but leaves room for seven new key/value pairs 316 in the right-side node 310D.

In addition to splitting the node 310B into nodes 310C and 310D at the leaf level, L(N), this example splitting operation also impacts one or more internal nodes above the new nodes 310C, 310D. More specifically, in b+-tree examples such as shown in FIG. 3B, when splitting the node 310B into the two nodes 310C and 310D, the filesystem driver 150 also creates a separator key in the parent node of both of the two new nodes 310C, 310D. In b+-tree examples, the separator key is an unpaired key, and is one of the keys from the set of key/value pairs 316A-316J that was split. In this example, it is the key with the largest key value in the left node 310C that becomes the separator key 312C added to the parent node 310A (e.g., having a key value of “88”, but no mapped value). In b-tree examples, one of the key/value pairs is moved up into the parent node 310A (e.g., either the key/value pair 316H, having the largest key value in the left node 310C, or the key/value pair 316I, having the smallest key value in the right node 310D). Further, the parent node 310A is updated to direct the pointer 314D to point to the left node 310C and the pointer 314E to point to the right node 310D.

In some situations, the addition of this new key 312C to the parent node 310A may, itself, cause that node 310A to have too many keys. As such, the filesystem driver 150 may similarly perform an unbalanced split of that node 310A. In such a situation, a new node (not shown) is added to the L(N−1) layer, and some of the keys 312A-312C are distributed to that new node (e.g., leaving 80% keys 312 in node 310A as the left node of the split, and moving the largest 20% of keys 312 from node 310A to the new node, being the right node of the split). While this redistribution of keys 312 at the L(N−1) level does not impact the nodes 310 below that level, some of the pointers 314 may be updated to reflect the new structure (e.g., to maintain the rules of the b*-tree). And like the unbalanced splitting at the leaf layer, L(N), unbalanced splitting above leaf layer also leaves more capacity for new keys 312 in the right node(s), thus setting up the tree 300 for future additions. Such additions of interior nodes may similarly cascade up the tree 300 until one of the parent nodes can accept a new node without splitting.

In some examples, the filesystem driver 150 performs unbalanced splits on split operations that occur on the right-most node of a given layer but performs conventional balanced splitting on split operations occurring on any other node of that layer (e.g., any node left of the right-most node of that layer). The examples of FIGS. 3A and 3B illustrate such a situation. In some examples, the filesystem driver 150 performs unbalanced splits on split operations that occur when adding a key 312 or key/value pair 316 whose key value is larger than any other key value in the tree 300. In some examples, the filesystem driver 150 performs unbalanced splits on any or all split operations within the tree 300.

In some examples, the filesystem driver 150 dynamically determines when to perform unbalanced splits instead of balanced splits. For example, the filesystem driver 150 tracks a history of the I/O operations performed on the LFS 120 and dynamically alters how often or when unbalanced splits are performed. In one example, the filesystem driver 150 toggles unbalanced splitting on or off based on a rate of appended writes (e.g., turning unbalanced splitting on when an append rate exceeds a predetermined threshold and reverting to balanced splitting when the append rate drops below the threshold). In another example, the filesystem driver 150 increases or decreases an unbalanced split chance variable as an append rate increases or decreases on the LFS 120, where the unbalanced split change variable is used to randomly determine whether or not to perform an unbalanced splits during any given split operation. In some examples, the filesystem driver 150 dynamically alters the proportion of splitting in split operations based on the append rate of the LFS 120. For example, 50/50 or 60/40 splits are used when the append rate is low, increasing to 70/30, 80/20, 90/10, or the like, as the append rate gets higher.

When such unbalanced splitting is used in conjunction with an append-heavy workload of the LFS 120, and particularly with the middle tree 132 (where the next MBA 143 to be assigned in the middle address space 142 may be monotonically increasing), the architecture 100 yields several technical benefits. For example, during a split operation on the right most leaf node 310B of the tree 300, the unbalanced nature of the split leaves capacity for new key/value pairs 316 to be added to the right-most leaf node 310D after the split. In append-heavy workloads, the next several operations are likely to prompt inserts of key values that are greater than the highest key value currently in the tree, and thus are likely to be added to the right-most leaf node 310D. Since more capacity for receiving new key/value pairs 316 is made available in the right-most leaf node 310D, the tree 300 is prepared to insert more key/value pairs 316 to the right-most leaf node 310D. For example, seven more key/value pairs 316 can be added before causing the next split operation, and thus the computational and storage overhead associated with such graph management can be reduced. Whenever split operations occur, this causes the filesystem driver 150 to perform restructuring of the tree 300. This overhead includes both computational processing (e.g., restructuring the tree 300 by creating new nodes, moving keys 312 or key/value pairs 316 around within the tree 300, and the like) as well as additional storage requirements (e.g., any changes to the tree 300 are written as log changes to the FS metadata 122 of the LFS 120). Further, the resulting b-tree nodes will be more compact for append-heavy workloads (e.g., the middle tree 132 uses fewer nodes, which can reduce cache miss ratio and improve performance). Thus any efficiencies that can be achieved by these unbalanced splits can yield both computational and storage efficiencies.

While the examples provided above presume b*-trees that order keys in increasing order from left to right, and in situations that use a monotonically increasing MBA 143, it should be understood that these methods can also be applied to b*-trees that order keys in decreasing order from left to right, and in situations that use a monotonically decreasing MBA 143. In such situations, reflective unbalanced operations are performed by the filesystem driver 150 (e.g., performing unbalanced splitting on the left side nodes of the tree 300, and the like). Further, the unbalanced splitting methods described herein also apply to other sorted trees that have nodes that can contain multiple keys and that split nodes. In addition, while the architecture 100 of FIG. 1 shows a three-layer mapping of address spaces 140, 142, 144, it should be understood that these unbalanced split methods may also be applied to two-layer mappings and 4+layer mappings. Additionally, while the example unbalanced split operations describe creating one new node and “moving” some keys or key/value pairs from an existing node to the new node, it should be understood that these split operations can, alternatively, delete the existing node and create two new nodes (e.g., saving all of the keys or key/value pairs and adding in those keys or key/value pairs into the two new nodes), as this effectively accomplishes the same result (e.g., an unbalanced split of one node into two nodes).

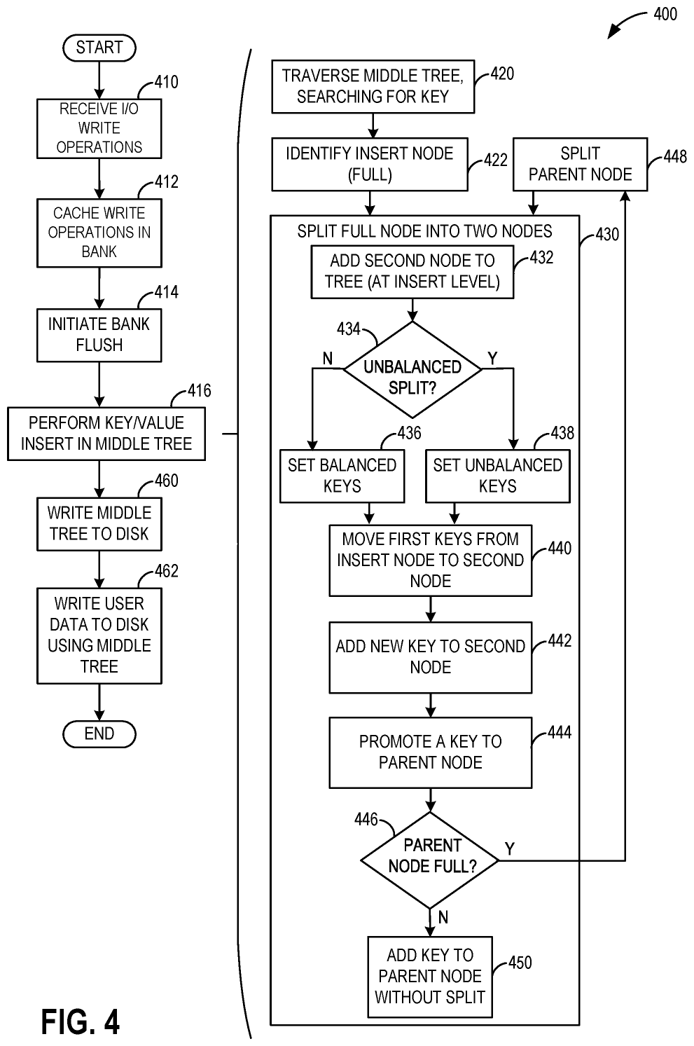

FIG. 4 is a flowchart 400 of an example process that implements unbalanced splits during management of the middle tree 132 shown in FIG. 1. In some embodiments, the filesystem driver 150 performs the operations shown in FIG. 4 within the architecture 100 of FIG. 1 using the tree 300 shown in FIG. 3A and FIG. 3B. In the example, the filesystem driver 150 receives I/O write operations (e.g., I/O ops 152) at operation 410. At operation 412, the filesystem driver 150 caches these write operations in a bank. At operation 414, the filesystem driver 150 initiates a bank flush operation (e.g., bank flush operation 154, after the bank is full). The performance of this bank flush operation is only partially illustrated in FIG. 4, specifically with regard to the operations involving the middle tree 132. Some operations regarding the bank flush are excluded from FIG. 4 as they do not necessarily pertain to the management of the middle tree 132 and the unbalanced split techniques described herein. At operation 416, the filesystem driver 150 performs a key/value insert in the middle tree 132 (e.g., as part of an insert operation 302 into the middle tree 132 during a write operation that was stored in the bank).

In this example, the key/value insert in the middle tree causes the filesystem driver 150 to traverse the middle tree 132 at operation 420, in search of a particular key (e.g., an LBA 141 identified by the key/value pair 316J of the insert operation 302 shown in FIG. 3A). At operation 422, the filesystem driver 150 identifies a leaf node (e.g., node 310B) within which to insert the new key/value pair 316J. However, the filesystem driver 150 also identifies that the node 310B is full at this time and, as such, initiates a split of the full node 310B into two nodes (e.g., nodes 310C and 310D of FIG. 3B) at operation 430.

The splitting of the full node 310B at operation 430 includes several operations in this example. At operation 432, the filesystem driver 150 adds a second node (e.g., node 310D) to the middle tree 132 (e.g., at the level of the identified node, which is the level of the leaf nodes, L(N) in this example). At test 434, the filesystem driver 150 determines whether to perform a balanced split at 436 or an unbalanced split at 438 (e.g., via any of the methods described above). In cases where a balanced split is determined to be performed at 436, the filesystem driver 150 identifies a balanced set of keys at 436 (e.g., identifying the smaller half of the keys from the original node for inclusion in the left-side node 310C and the larger half of the keys from the original node for inclusion in the right-side node 310D, including the new key). In cases where an unbalanced split is determined to be performed at 438, the filesystem driver 150 at 438 identifies a set of keys to add to the left-side node 310C (e.g., 80% of the keys from the original node plus the new key, based on key value, the first subset 320A) and another set of keys to add to the right-side node 310D (e.g., the remaining 20% of the keys plus the new key, based on key value, the second subset 320B).

At operation 440, the filesystem driver 150 moves the other, second set of keys from the node 310B (which is now also presumed to be the left-side node 310C) to the right-side node 310D. In addition, the new key is added to the new node (e.g., the right-side node 310D) at operation 442. As such, the original keys plus the new key have thus been distributed between the left-side node 310C and the right-side node 310D, in an unbalanced fashion, favoring more keys to the left-side node 310C.

At operation 444, the filesystem driver 150 promotes one of the keys of these two nodes 310C, 310D to a parent node (e.g., node 310A). At test 446, the filesystem driver 150 determines whether or not this parent node 310A was already full (e.g., before the promotion of one of the keys). If the parent node 310A was already full, then a split of the parent node 310A is initiated at operation 448, and the same operations are performed to split that parent node 310A. In some examples, if the parent node 310A is also the right-most node at that layer, that node 310A may also undergo an unbalanced split. The splitting of parent nodes may, as such, cascade up the tree 132 until no further splitting is needed.

Returning to test 446, if the parent node 310A is not full, then the selected key is added to the parent node without splitting the parent node at operation 450 and the filesystem driver 150 returns to operation 416. The bank flush of operation 414 may include several insertions into the middle tree 132 and, as such, operations 420-450 may be performed again for each insertion. At operation 460, the filesystem driver 150 writes the updated middle tree 132 to disk (e.g., to the FS metadata 122 of the LFS 120) and proceeds to write user data to disk (e.g., to the FS user data 124 of the LFS 120) using the middle tree 132 at operation 462.

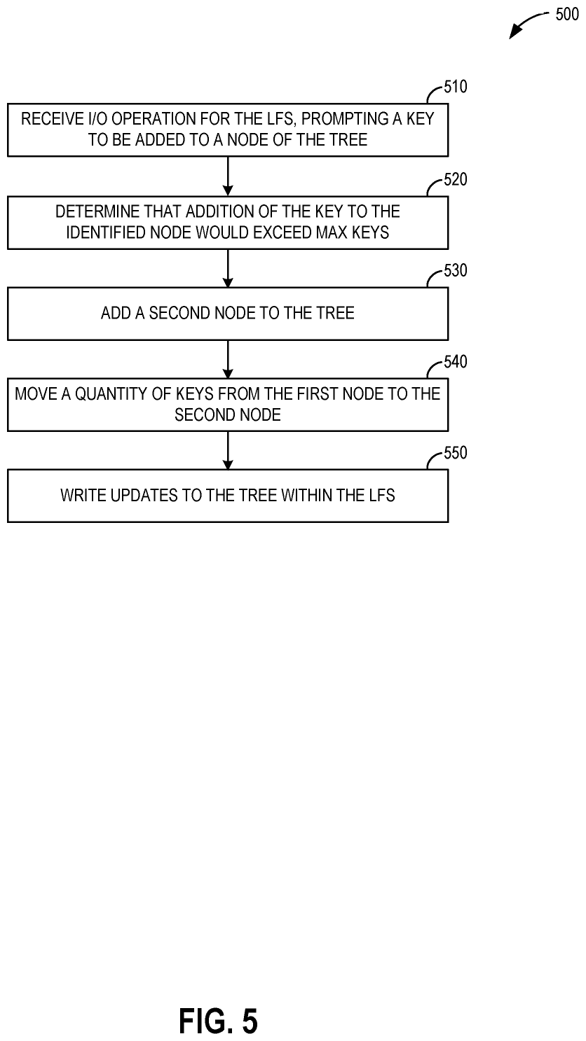

FIG. 5 is a flowchart of an example method 500 managing an LFS on a computing device. In some examples, the method 500 is performed by the filesystem driver 150 within the architecture 100 as shown in FIG. 1. In some examples, the method 500 operates on the tree 300 shown in FIG. 3A and FIG. 3B (e.g., as one or more of the logical tree 130 and the middle tree 132 of the LFS 120 shown in FIG. 1). In the example, at operation 510, the filesystem driver 150 receives an input/output (I/O) operation for the LFS, where the I/O operation prompts a key to be added to a first node of a tree metadata structure, and the tree metadata structure maps addresses in a first address space to addresses in a second address space. In some examples, the tree metadata structure is one of a b-tree and a b+-tree. In some examples, the first node is one of a right-most leaf node or a left-most leaf node of the tree metadata structure. In some examples, the tree metadata structure maps a middle address space of the LFS to a physical address space of the LFS, the physical address space identifying blocks of persistent storage used by the LFS. In some examples, the key is paired with a mapped value, wherein the key identifies a key value, the key value being a virtual address in the middle address space, wherein the mapped value is an address of one or more blocks of the persistent storage.

At operation 520, the filesystem driver 150 determines that addition of the key to the first node would exceed a maximum number of keys allowed in the first node. At operation 530, the filesystem driver 150 adds a second node to the tree metadata structure based on the determining, the second node containing the key. At operation 540, the filesystem driver 150 moves a quantity of keys from the first node to the second node such that the total number of keys resulting in the second node is less than half of the maximum number of keys, minus one, configured to be stored in nodes of the LFS. At operation 550, the filesystem driver 150 writes updates to the tree metadata structure within the LFS.

In some examples, the filesystem driver 150 performs a balanced split operation of nodes in the tree metadata structure for any node splits involving nodes that are not a right-most node of a layer of the tree metadata structure. In some examples, the filesystem driver 150 traverses the tree metadata structure resulting in the location of the key, the key being a first address in the middle address space, identifies, from the tree metadata structure based on the traversing, the address of the one or more blocks associated with the key, and performs a write operation to the persistent storage using the one or more blocks.

Examples of architecture 100 are operable with virtualized and non-virtualized storage solutions. FIG. 6 illustrates a virtualization architecture 600 that may be used as a version of computing platform. Virtualization architecture 600 is comprised of a set of compute nodes 621-623, interconnected with each other and a set of storage nodes 641-643 according to an embodiment. In other examples, a different number of compute nodes and storage nodes is used. Each compute node hosts multiple objects, which may be virtual machines (VMs, such as base objects, linked clones, and independent clones), containers, applications, or any compute entity (e.g., computing instance or virtualized computing instance) that consumes storage, such as local storage 661, 662, 663 (e.g., storage devices directly attached to the compute nodes 621, 622, 623) or storage provided by other devices or services (e.g., SAN storage, network-attached storage (NAS), cloud storage, storage provided by storage nodes 641, 642, 643, or the like). When objects are created, they may be designated as global or local, and the designation is stored in an attribute. For example, compute node 621 hosts objects 601, 602, and 603; compute node 622 hosts objects 604, 605, and 606; and compute node 623 hosts objects 607 and 608. Some of objects 601-608 may be local objects. In some examples, a single compute node hosts 50, 100, or a different number of objects. Each object uses a VM disk (VMDK), for example VMDKs 611-618 for each of objects 601-608, respectively. Other implementations using different formats are also possible. A virtualization platform 630, which includes hypervisor functionality at one or more of compute nodes 621, 622, and 623, manages objects 601-608. In some examples, various components of virtualization architecture 600, for example compute nodes 621, 622, and 623, and storage nodes 641, 642, and 643 are implemented using one or more computing apparatus such as computing apparatus 718 of FIG. 7.

Virtualization software that provides software-defined storage (SDS), by pooling storage nodes across a cluster, creates a distributed, shared data store, for example a storage area network (SAN). Thus, objects 601-608 may be virtual SAN (vSAN) objects. In some distributed arrangements, servers are distinguished as compute nodes (e.g., compute nodes 621, 622, and 623) and storage nodes (e.g., storage nodes 641, 642, and 643). Although a storage node may attach a large number of storage devices (e.g., flash, solid state drives (SSDs), non-volatile memory express (NVMe), Persistent Memory (PMEM), quad-level cell (QLC)) processing power may be limited beyond the ability to handle input/output (I/O) traffic. Storage nodes 641-643 each include multiple physical storage components, which may include flash, SSD, NVMe, PMEM, and QLC storage solutions. For example, storage node 641 has storage 651, 652, 652, and 653; storage node 642 has storage 655 and 656; and storage node 643 has storage 657 and 658. In some examples, a single storage node includes a different number of physical storage components.

In the described examples, storage nodes 641-643 are treated as a SAN with a single global object, enabling any of objects 601-608 to write to and read from any of storage 651-658 using a virtual SAN component 632. Virtual SAN component 632 executes in compute nodes 621-623. Using the disclosure, compute nodes 621-623 are able to operate with a wide range of storage options. In some examples, compute nodes 621-623 each include a manifestation of virtualization platform 630 and virtual SAN component 632. Virtualization platform 630 manages the generating, operations, and clean-up of objects 601 and 602. Virtual SAN component 632 permits objects 601 and 602 to write incoming data from object 601 and incoming data from object 602 to storage nodes 641, 642, and/or 643, in part, by virtualizing the physical storage components of the storage nodes.

### ADDITIONAL EXAMPLES

An example method of managing an LFS on a computing device comprises: receiving an input/output (I/O) operation for the LFS, the I/O operation prompting a key to be added to a first node of a tree metadata structure, the tree metadata structure mapping addresses in a first address space to addresses in a second address space; determining that addition of the key to the first node would exceed a maximum number of keys allowed in the first node; adding a second node to the tree metadata structure based on the determining, the second node containing the key; moving a quantity of keys from the first node to the second node such that a total number of keys resulting in the second node is less than half of the maximum number of keys, minus one, configured to be stored in nodes of the LFS; and writing updates to the tree metadata structure within the LFS.

An example computer system comprises: a persistent storage device storing a LFS, the LFS including a tree metadata structure and user data; at least one processor; and a non-transitory computer readable medium having stored thereon program code executable by the at least one processor, the program code causing the at least one processor to: receive an input/output (I/O) operation for the LFS, the I/O operation prompting a key to be added to a first node of the tree metadata structure, the tree metadata structure mapping addresses in a first address space to addresses in a second address space; determine that addition of the key to the first node would exceed a maximum number of keys allowed in the first node; add a second node to the tree metadata structure based on the determining, the second node containing the key; move a quantity of keys from the first node to the second node such that a total number of keys resulting in the second node is less than half of the maximum number of keys, minus one, configured to be stored in nodes of the LFS; and write updates to the tree metadata structure within the LFS.

An example non-transitory computer storage medium has stored thereon program code executable by a processor, the program code embodying a program code method comprises: receiving an input/output (I/O) operation for an LFS, the I/O operation prompting a key to be added to a first node of a tree metadata structure, the tree metadata structure mapping addresses in a first address space to addresses in a second address space; determining that addition of the key to the first node would exceed a maximum number of keys allowed in the first node; adding a second node to the tree metadata structure based on the determining, the second node containing the key; moving a quantity of keys from the first node to the second node such that a total number of keys resulting in the second node is less than half of the maximum number of keys, minus one, configured to be stored in nodes of the LFS; and writing updates to the tree metadata structure within the LFS.

Another example computer system comprises: a processor; and a non-transitory computer readable medium having stored thereon program code executable by the processor, the program code causing the processor to perform a method disclosed herein. Another example non-transitory computer storage medium has stored thereon program code executable by a processor, the program code embodying a method disclosed herein.

Alternatively, or in addition to the other examples described herein, examples include any combination of the following:
an LFS that uses b*-trees as metadata trees for mapping addresses between a first address space and a second address space;
receiving an input/output (I/O) operation for the LFS;
an I/O operation prompting a key to be added to a first node of a tree metadata structure;
a tree metadata structure mapping addresses in a first address space to addresses in a second address space;
determining that addition of the key to the first node would exceed a maximum number of keys allowed in the first node;
adding new node(s) to the tree metadata structure;
adding a new node that contains a new key or key/value pair;
moving a quantity of keys from a first node to a second node such that a total number of keys resulting in the second node is less than half of the maximum number of keys, minus one, configured to be stored in nodes of the LFS;
deleting keys or key/value pairs from a node;
writing updates to a tree metadata structure within an LFS;
a tree metadata structure is one of a b-tree and a b+-tree;
a first node is one of a right-most leaf node or a left-most leaf node of the tree metadata structure;
performing a balanced split operation of nodes in the tree metadata structure for any node splits involving nodes that are not a right-most node of a layer of the tree metadata structure;
distinguishing when to perform balanced split operations or unbalanced split operations based on append operations;
a tree metadata structure that maps a middle address space or virtual address space of an LFS to a physical address space of the LFS;
a physical address space identifies blocks of persistent storage used by the LFS;
a key is paired with a mapped value;
a key identifies a key value;
a key value is a virtual address in the middle address space;
a mapped value is an address of one or more blocks of the persistent storage;
traversing a tree metadata structure resulting in a location of the key, the key being a first address in the middle address space;
identifying, from the tree metadata structure based on the traversing, the address of the one or more blocks associated with the key;
performing a write operation to the persistent storage using the one or more blocks;
performing unbalanced splits in a tree graph;
dynamically performing unbalanced splits in a tree graph based on whether a workload of a filesystem is append-heavy;
performing an unbalanced split when an insertion node is full;
performing an unbalanced split when an insertion key has a key value greater than all other keys in a tree;
performing an unbalanced split includes splitting 60% of a set of keys to one node and 40% of keys to another node;
performing an unbalanced split includes splitting 70% of a set of keys to one node and 30% of keys to another node;
performing an unbalanced split includes splitting 80% of a set of keys to one node and 20% of keys to another node;
performing an unbalanced split includes splitting 90% of a set of keys to one node and 10% of keys to another node;
performing an unbalanced split includes splitting 100% of a set of keys to one node and 0% of keys to another node;
performing an unbalanced split includes configuring one node with a supermajority of keys to one node and a remainder of keys to another node;
performing an unbalanced split includes configuring one node with a simple majority of keys to one node and a remainder of keys to another node;
a tree that maps addresses in a logical address space to addresses in one of a middle address space or a virtual address space;
a tree that maps addresses in one of a middle address space and a virtual address space to a physical address space; and
adding pointers to parent nodes in a tree during an unbalanced split.

### Exemplary Operating Environment

The present disclosure is operable with a computing device (e.g., computing apparatus) according to an embodiment shown as a functional block diagram 700 in FIG. 7. FIG. 7 illustrates a block diagram of an example computing apparatus that may be used as a component of the architectures of FIG. 1 and FIG. 6. In an embodiment, components of a computing apparatus 718 are implemented as part of an electronic device according to one or more embodiments described in this specification. The computing apparatus 718 comprises one or more processors 719 which may be microprocessors, controllers, or any other suitable type of processors for processing computer executable instructions to control the operation of the electronic device. Alternatively, or in addition, the processor 719 is any technology capable of executing logic or instructions, such as a hardcoded machine. Platform software comprising an operating system 720 or any other suitable platform software may be provided on the computing apparatus 718 to enable application software 721 to be executed on the device. According to an embodiment, the operations described herein may be accomplished by software, hardware, and/or firmware.

Computer executable instructions may be provided using any computer-readable medium (e.g., any non-transitory computer storage medium) or media that are accessible by the computing apparatus 718. Computer-readable media may include, for example, computer storage media such as a memory 722 and communications media. Computer storage media, such as a memory 722, include volatile and non-volatile, removable, and non-removable media implemented in any method or technology for storage of information such as computer readable instructions, data structures, program modules or the like. Computer storage media include, but are not limited to, hard disks, RAM, ROM, EPROM, EEPROM, NVMe devices, persistent memory, phase change memory, flash memory or other memory technology, compact disc (CD, CD-ROM), digital versatile disks (DVD) or other optical storage, magnetic cassettes, magnetic tape, magnetic disk storage, shingled disk storage or other magnetic storage devices, or any other non-transmission medium (e., non-transitory) that can be used to store information for access by a computing apparatus. In contrast, communication media may embody computer readable instructions, data structures, program modules, or the like in a modulated data signal, such as a carrier wave, or other transport mechanism. As defined herein, a computer storage medium or media do not include communication media. Therefore, a computer storage medium should not be interpreted to be a propagating signal per se. Propagated signals per se are not examples of computer storage media. Although the computer storage medium (the memory 722) is shown within the computing apparatus 718, it will be appreciated by a person skilled in the art, that the storage may be distributed or located remotely and accessed via a network or other communication link (e.g., using a communication interface 723). Computer storage media are tangible, non-transitory, and are mutually exclusive to communication media.

The computing apparatus 718 may comprise an input/output controller 724 configured to output information to one or more output devices 725, for example a display or a speaker, which may be separate from or integral to the electronic device. The input/output controller 724 may also be configured to receive and process an input from one or more input devices 726, for example, a keyboard, a microphone, or a touchpad. In one embodiment, the output device 725 also acts as the input device. An example of such a device may be a touch sensitive display. The input/output controller 724 may also output data to devices other than the output device, e.g., a locally connected printing device. In some embodiments, a user may provide input to the input device(s) 726 and/or receive output from the output device(s) 725.

The functionality described herein can be performed, at least in part, by one or more hardware logic components. According to an embodiment, the computing apparatus 718 is configured by the program code when executed by the processor 719 to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Program-specific Standard Products (ASSPs), System-on-a-chip systems (SOCs), Complex Programmable Logic Devices (CPLDs), Graphics Processing Units (GPUs).

Although described in connection with an exemplary computing system environment, examples of the disclosure are operative with numerous other general purpose or special purpose computing system environments or configurations. Examples of well-known computing systems, environments, and/or configurations that may be suitable for use with aspects of the disclosure include, but are not limited to, mobile computing devices, personal computers, server computers, hand-held or laptop devices, multiprocessor systems, gaming consoles, microprocessor-based systems, set top boxes, programmable consumer electronics, mobile telephones, network PCs, minicomputers, mainframe computers, distributed computing environments that include any of the above systems or devices.

Examples of the disclosure may be described in the general context of computer-executable instructions, such as program modules, executed by one or more computers or other devices. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions or the specific components or modules illustrated in the figures and described herein. Other examples of the disclosure may include different computer-executable instructions or components having more or less functionality than illustrated and described herein.

Aspects of the disclosure transform a general-purpose computer into a special purpose computing device when programmed to execute the instructions described herein. The detailed description provided above in connection with the appended drawings is intended as a description of a number of embodiments and is not intended to represent the only forms in which the embodiments may be constructed, implemented, or utilized. Although these embodiments may be described and illustrated herein as being implemented in devices such as a server, computing devices, or the like, this is only an exemplary implementation and not a limitation. As those skilled in the art will appreciate, the present embodiments are suitable for application in a variety of different types of computing devices, for example, PCs, servers, laptop computers, tablet computers, etc.

The term “computing device” and the like are used herein to refer to any device with processing capability such that it can execute instructions. Those skilled in the art will realize that such processing capabilities are incorporated into many different devices and therefore the terms “computer”, “server”, and “computing device” each may include PCs, servers, laptop computers, mobile telephones (including smart phones), tablet computers, and many other devices. Any range or device value given herein may be extended or altered without losing the effect sought, as will be apparent to the skilled person. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

While no personally identifiable information is tracked by aspects of the disclosure, examples may have been described with reference to data monitored and/or collected from the users. In some examples, notice may be provided to the users of the collection of the data (e.g., via a dialog box or preference setting) and users are given the opportunity to give or deny consent for the monitoring and/or collection. The consent may take the form of opt-in consent or opt-out consent.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure. It will be understood that the benefits and advantages described above may relate to one embodiment or may relate to several embodiments. When introducing elements of aspects of the disclosure or the examples thereof, the articles “a,” “an,” and “the” are intended to mean that there are one or more of the elements. The terms “comprising,” “including,” and “having” are intended to be inclusive and mean that there may be additional elements other than the listed elements. The term “exemplary” is intended to mean “an example of.”

Having described aspects of the disclosure in detail, it will be apparent that modifications and variations are possible without departing from the scope of aspects of the disclosure as defined in the appended claims. As various changes may be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A computerized method of managing a log-structured file system (LFS) on a computing device, the method comprising:
receiving an input/output (I/O) operation for the LFS, the I/O operation prompting a key to be added to a first node of a tree metadata structure, the tree metadata structure mapping addresses in a first address space to addresses in a second address space;
determining that addition of the key to the first node would exceed a maximum number of keys allowed in the first node;
adding a second node to the tree metadata structure based on the determining, the second node containing the key;
moving a quantity of keys from the first node to the second node such that a total number of keys resulting in the second node is less than half of the maximum number of keys, minus one, configured to be stored in the second node of the LFS; and
writing updates to the tree metadata structure within the LFS.

2. The computerized method of claim 1, wherein the tree metadata structure is one of a b-tree and a b+-tree.

3. The computerized method of claim 1, wherein the first node is one of a right-most leaf node or a left-most leaf node of the tree metadata structure.

4. The computerized method of claim 3, further comprising performing a balanced split operation of nodes in the tree metadata structure for any node splits involving nodes that are not a right-most node of a layer of the tree metadata structure.

5. The computerized method of claim 1, wherein the tree metadata structure maps a middle address space of the LFS to a physical address space of the LFS, the physical address space identifying blocks of persistent storage used by the LFS.

6. The computerized method of claim 5, wherein the key is paired with a mapped value, wherein the key identifies a key value, the key value being a virtual address in the middle address space, wherein the mapped value is an address of one or more blocks of the persistent storage.

7. The computerized method of claim 6, further comprising:
traversing the tree metadata structure resulting in a location of the key, the key being a first address in the middle address space;
identifying, from the tree metadata structure based on the traversing, the address of the one or more blocks associated with the key; and
performing a write operation to the persistent storage using the one or more blocks.

8. A computer system comprising:
a persistent storage device storing a log-structured file system (LFS), the LFS including a tree metadata structure and user data;
at least one processor; and
a non-transitory computer readable medium having stored thereon program code executable by the at least one processor, the program code causing the at least one processor to:
receive an input/output (I/O) operation for the LFS, the I/O operation prompting a key to be added to a first node of the tree metadata structure, the tree metadata structure mapping addresses in a first address space to addresses in a second address space;
determine that addition of the key to the first node would exceed a maximum number of keys allowed in the first node;
add a second node to the tree metadata structure based on the determining, the second node containing the key;
move a quantity of keys from the first node to the second node such that a total number of keys resulting in the second node is less than half of the maximum number of keys, minus one, configured to be stored in the second node of the LFS; and
write updates to the tree metadata structure within the LFS.

9. The computer system of claim 8, wherein the tree metadata structure is one of a b-tree and a b+-tree.

10. The computer system of claim 8, wherein the first node is one of a right-most leaf node or a left-most leaf node of the tree metadata structure.

11. The computer system of claim 10, wherein the program code further causes the at least one processor to perform a balanced split operation of nodes in the tree metadata structure for any node splits involving nodes that are not a right-most node of a layer of the tree metadata structure.

12. The computer system of claim 8, wherein the tree metadata structure maps a middle address space of the LFS to a physical address space of the LFS, the physical address space identifying blocks of the persistent storage device used by the LFS.

13. The computer system of claim 12, wherein the key is paired with a mapped value, wherein the key identifies a key value, the key value being a virtual address in the middle address space, wherein the mapped value is an address of one or more blocks of the persistent storage.

14. The computer system of claim 13, wherein the program code further causes the at least one processor to:
traverse the tree metadata structure resulting in a location of the key, the key being a first address in the middle address space;
identify, from the tree metadata structure based on the traversing, the address of the one or more blocks associated with the key; and
perform a write operation to the persistent storage using the one or more blocks.

15. A non-transitory computer storage medium having stored thereon program code executable by a processor, the program code embodying a program code method comprising:
receiving an input/output (I/O) operation for a log-structured file system (LFS), the I/O operation prompting a key to be added to a first node of a tree metadata structure, the tree metadata structure mapping addresses in a first address space to addresses in a second address space;
determining that addition of the key to the first node would exceed a maximum number of keys allowed in the first node;
adding a second node to the tree metadata structure based on the determining, the second node containing the key;
moving a quantity of keys from the first node to the second node such that a total number of keys resulting in the second node is less than half of the maximum number of keys, minus one, configured to be stored in the second node of the LFS; and
writing updates to the tree metadata structure within the LFS.

16. The non-transitory computer storage medium of claim 15, wherein the tree metadata structure is one of a b-tree and a b+-tree.

17. The non-transitory computer storage medium of claim 15, wherein the first node is one of a right-most leaf node or a left-most leaf node of the tree metadata structure.

18. The non-transitory computer storage medium of claim 17, wherein the program code method further comprises performing a balanced split operation of nodes in the tree metadata structure for any node splits involving nodes that are not a right-most node of a layer of the tree metadata structure.

19. The non-transitory computer storage medium of claim 15, wherein the tree metadata structure maps a middle address space of the LFS to a physical address space of the LFS, the physical address space identifying blocks of persistent storage used by the LFS.

20. The non-transitory computer storage medium of claim 19, wherein the key is paired with a mapped value, wherein the key identifies a key value, the key value being a virtual address in the middle address space, wherein the mapped value is an address of one or more blocks of the persistent storage.
